(19) United States
(12) Patent Application Publication
(10) Pub. No.: US 2024/0094589 A1
(43) Pub. Date: Mar. 21, 2024

(54) ELECTROCHROMIC DEVICE

(71) Applicants: UNIVERSITE DE BORDEAUX, Bordeaux (FR); CENTER NATIONAL DE LA RECHERCHE SCIENTIFIQUE - CNRS, Paris (FR); INSTITUT POLYTECHNIQUE DE BORDEAUX, Talence (FR); GROUPE LUQUET DURANTON, Annonay (FR)

(72) Inventors: Aline ROUGIER, Pessac (FR); Romain FUTSCH, Bordeaux (FR)

(21) Appl. No.: 18/043,975

(22) PCT Filed: Sep. 7, 2021
(86) PCT No.: PCT/FR2021/051526

§ 371 Date: Mar. 3, 2023

(30) Foreign Application Priority Data
Sep. 8, 2020 (FR) FR2009101

(51) Int. Cl. G02F 1/155; G02F 1/1516; G02F 1/157

(52) U.S. Cl. CPC G02F 1/155; G02F 1/15165; G02F 1/157; G02F 2001/1555; G02F 2001/164

(57) ABSTRACT

The invention relates to an electrochromic device (50). According to the invention, it comprises: —at least one substrate (51); —a first electrode (53) comprising a first opening (52) and a second electrode (54) comprising a second opening (55); —the two electrodes being positioned so that the two openings are opposite each other; —a layer (56) of electrochromic material adapted to be arranged relative to the first opening (52) of the first electrode so as to form at least one electrical contact zone between the layer of electrochromic material and the first electrode, said layer of electrochromic material and said first electrode thus together forming a working electrode and the second electrode forming a counter-electrode; —a layer (57) of electrolyte sandwiched between the working electrode and the counter-electrode; —an electrical power supply means configured to apply an electric voltage to the two electrodes.

### TECHNICAL FIELD

The invention relates to an electrochromic device with optical properties controlled with electrical commands. It relates also to the use of such a device for the most wide-ranging applications.

### PRIOR ART

An electrochromic device, which can be likened to an optical battery, is an electrical device capable of being able to modulate its optical properties under the application of an electrical field, thus making it possible to obtain an electrically controlled coating in which changes of color or of light transmission capacity can easily be adjusted. Such coatings have demonstrated applications in the most wide-ranging technical fields.

Thus, they can be used as glazing units of a dwelling in order, for example, to adjust the level of sunlight in a room according to the outside conditions and the wishes of the users. They can also be used, in the motor vehicle domain, as windshield and/or side windows or glazing of the roof of a car, in order to control the level of transparency and notably be able to control the light rays transmitted to the driver to avoid any glare to the latter. They can also be used as data display screen. Applications in the infrared range are also being developed, such as thermal protection in the space domain for satellites, and infrared camouflage in the military domain.

According to a first configuration and as FIG. 1A illustrates, the electrochromic devices 10 are composed of five layers held captive between two substrates 11, 12: a layer of an electrolyte material 17 interposed between two layers of materials 15, 16, at least one of which is an electrochromic material (with anodic or cathodic coloring), the layers of electrochromic materials being each in contact, by their outer face, with a layer of a current collector material and that is transparent in the visible 13, 14. These devices are manufactured by a succession of layers thus forming a stack: Substrate 1/TCO1/EC1/EL/EC2/TCO2/Substrate 2 in which at least one of the substrates is a transparent material chosen notably from among glass, plastic, etc., the other substrate being able to be opaque (paper for example) or reflective (metal for example), TCO1 and TCO2 are electronically conductive transparent oxides (TCO standing for “Transparent Conductive Oxide”) used as current collector, EC1 and EC2 are electrochromic materials with hybrid conduction (ionic and electronic) and EL is an electrolyte material with ionic conduction. This stack of materials is also called “electrochromic cell”.

The electrochromic device operates as follows. A potential difference is applied between the two electronic conductors by means of an electrical power supply not illustrated in FIG. 1. Under the effect of this potential difference, the ions in the electrolyte are displaced from one electrochromic material to another. Simultaneously, through the input of the electrons from the electrode in contact with the electrochromic material, the degree of oxidation of the electrochromic material is modified leading to a change of its optical properties, notably the color. Furthermore, a reversal of the field effect makes it possible to displace the ions and electrons out of the electrochromic material, which will thus revert to its initial color reversibly. The electrochromic layer is characterized by at least two states with distinct optical properties: the oxidized state and the reduced state. As an example, a layer of tungsten oxide is characterized by a transition from a blue coloring state to a state of neutral appearance.

The oxides that can be used as TCO1 and TCO2 need to have a high electrical conductivity (>10³ S·cm⁻¹), associated with an average transmission of the order of 85% in the visible to be able to observe the change of color in the layer of electrochromic material. To achieve this transmission, the layers of TCOs are generally of small thickness, of the order of 150 nm. The oxides most widely used as TCO are tin-doped indium oxide In₂O₃:Sn (ITO) closely followed by fluorine-doped tin oxide SnO₂:F (FTO) and gallium- or aluminum-doped zinc oxide.

The electrochromic devices with five layers as described above are however costly to manufacture and do not always exhibit speed of switching and sufficient contrast.

The inventors have developed an electrochromic device with three or four layers which is less costly and easier to manufacture while minimizing the switching time and the energy needed for operation. Such an electrochromic device is described in more detail in the document WO2014/135804.

FIG. 1B illustrates an electrochromic device 20 with four layers comprising:
an electrically conductive layer TCO 23;
a layer of electrochromic material EC1 25 in contact with the conductive layer TCO;
a counter-electrode layer 24 of conductive metallic material M;
a layer of electrolyte 27 in contact with the electrode layer 24 and the layer of electrochromic material 25.

The electrochromic cell formed by four layers is sandwiched between two substrates 21, 22.

The use of a metallic material as counter-electrode makes it possible to dispense with the need to use a second electrically conductive layer TCO which would be in contact with the counter-electrode, because the metallic material constituting the counter-electrode is itself conductive. That makes it possible to reduce the number of layers to four.

FIG. 1C illustrates an electrochromic device 30 with three layers comprising:
an electrochromic layer 33 ECM exhibiting sufficient electronic conductivity;
a layer of electrolyte 37 EL;
a metallic counter-electrode layer 34 M.

The electrochromic cell with three layers is sandwiched between two substrates 31, 32.

The use of a material that is both electrochromic and electrically conductive makes it possible to dispense with the presence of the TCO layer which would be in contact with the electrochromic layer. The electrochromic device is then solely composed of three layers.

Two architectures are distinguished in the manufacturing of electrochromic devices: vertical architecture and coplanar architecture.

FIGS. 1A-1C illustrate a vertical architecture in which the electrochromic device is manufactured either by a succession of layers: each layer is deposited on top of the preceding layer, thus creating a stack, or by the assembly via the electrolytic layer of two half-stacks.

FIGS. 2A-2C illustrate the electrochromic device with three layers in a coplanar architecture 40 in which the electrochromic layer ECM 43 with sufficient electronic conductivity and the metallic counter-electrode M 44 are disposed side-by-side without being in contact, in a same plane, and are in contact with a second substrate 42 and the electrolyte 47, the electrolyte itself being supported by a first substrate 41.

### Technical Problem

Although these devices give full satisfaction in terms of operation, the manufacturing thereof imposes constraints in the choice of the materials used for the substrates, the electrodes, the electrochromic material and the electrolyte, whether in the vertical architecture or in the coplanar architecture. Indeed, in the vertical architecture, when the first substrate forms, for example, the display surface, it must necessarily be produced in a transparent material such as glass or PET or a translucent material such as tracing paper. In the case of the electrochromic device with five layers and with four layers, the material forming the electrically conductive layer must also be transparent. The substrate of the counter-electrode layer can be an opaque, translucent or transparent material that can for example be chosen from among papers, plastics, textile materials, glasses, metals, ceramics, wood, etc. In the case of the electrochromic device with five layers, the working electrode must also be transparent.

In the coplanar architecture, when the first substrate in contact with the working electrode forms, for example, the display surface, it is necessarily chosen from among the translucent materials such as tracing paper or transparent materials such as glass or PET for example. The layer of electrolyte must also be transparent. The substrate 2 of the counter-electrode can be an opaque, translucent or transparent material that can for example be chosen from among papers, textile materials, glasses, metals, ceramics, wood, etc.

Thus, whatever the architecture and the number of layers forming the electrochromic device, physical and chemical constraints must be taken into account in the choice of the electrochromic materials to form the working electrode layer and in the choice of the materials to form the layer of electrolyte.

For example, in the case of an electrochromic device with five layers, at least one of the two electrodes must be transparent to make it possible to see a change of color through a transparent substrate. ITO is generally used as transparent electrode. However, this material can be difficult to print. The electrochromic devices of the state of the art cannot therefore be fully printed, rendering manufacture more complex and more costly. Likewise, ITO also incurs a high manufacturing cost due to the use of indium.

In the case of the electrochromic device with three layers, the layer of electrolyte must be chosen not only from a transparent material to make it possible to see a change of color through a transparent substrate, but it must also allow sufficient ionic conduction to allow the electrochromic material to change color. It must also be chemically compatible with the adjacent layers, and notably allow the deposition of another layer on top of the electrolyte. Finally, the electrolyte material must ensure an electrical isolation between the two electrodes.

Moreover, the electrochromic devices of the state of the art generally necessitate the use of two substrates, one of which serves as support and the other of which is intended to protect the electrochromic cell or support.

The present invention therefore aims to mitigate the drawbacks described above by proposing a novel electrochromic device architecture which makes it possible to overcome the constraints in the choice of the materials used, which are less costly and easier to manufacture by comparison with the electrochromic devices of the prior art.

### SUMMARY OF THE INVENTION

The subject of the present invention is therefore an electrochromic device comprising
at least one substrate;
a first electrode comprising a first aperture and a second electrode comprising a second aperture;
the two electrodes being positioned such that the two apertures are opposite;
a layer of electrochromic material adapted to be arranged with respect to the first aperture of the first electrode so as to form at least one electrical contact zone between the layer of electrochromic material and the first electrode, said layer of electrochromic material and said first electrode thus together forming a working electrode and the second electrode forming a counter-electrode;
a layer of electrolyte sandwiched between the working electrode and the counter-electrode;
an electrical power supply means configured to apply an electrical voltage to the two electrodes.

The first aperture and the second aperture have a closed outline with any geometrical form. It can be square as in the two examples represented below, or rectangular, or circular, or oval, or of any other suitable form. The two apertures pass in a vertical plane through the thickness of the electrode layers.

In this novel electrochromic device architecture, by virtue of the presence of the apertures, the electrochromic material is not fully deposited on the electrode, unlike in the existing vertical architectures. The viewing of its change of color is thereby no longer obstructed by the electrode. That makes it possible to dispense with the constraints on the choice of the materials of the electrodes and widen the list of the materials, and notably dispense with the need to use an electrode which would be both conductive and transparent. That makes it possible to notably reduce the cost of manufacture of the electrochromic device. In particular, the novel architecture makes it possible to replace ITO, which is generally used as transparent electrode with other, less expensive materials while making manufacture easier.

The novel architecture also makes it possible to deposit the different layers entirely by printing, and the printing techniques that can be cited include screen-printing, inkjet printing, flexography, slot-die printing and rotogravure. The novel architecture is also compatible with other deposition techniques such as cathodic sputtering and sol-gel.

The different parts of the electrochromic device can be prepared and assembled by existing thin-film production techniques such as, for example, roller coating, flexography, screen-printing, dipping-removal, spin-coating, application by coating knife, etc., or a combination of these techniques.

The fact of no longer having to deposit the layer of electrochromic material on the electrode makes it possible to avoid any visual alteration of the electrochromic material, and thus enhance the optical contrast, and therefore increase the functional quality of the electrochromic device.

According to another advantage resulting from this novel architecture, the presence of the aperture in the electrode makes it possible to use the substrate as background to the electrochromic material to observe a change of color more distinctly.

The manufacturing of the electrochromic device of the present invention entails the use of a single substrate instead of two that are generally demanded in the electrochromic devices of the state of the art.

According to one embodiment of the invention, the electrolyte that can be used in the electrochromic device can notably be chosen from among:
i) ionic liquids gelled or plasticized by at least one gelling or plasticizing agent;
ii) ionic liquids mixed with a thermo- or UV photo-polymerizable monomer/oligomer,
iii) electrolytic solutions of at least one electrolyte salt and/or of at least one acid in solution in a solvent, said solutions being gelled or plasticized by at least one gelling or plasticizing agent,
iv) electrolytic solutions comprising at least one oxide,
v) thin layers of a material chosen from among certain hydrated oxides such as, for example, hydrated Ta₂O₅ and hydrated ZrO₂.

The nature of the ionic liquids that can be used according to the invention is not critical. The ionic liquids are defined as being organic salts with a melting point lower than or equal to the boiling point of water. They generally take the form of liquids at ambient temperature and atmospheric pressure without the addition of solvent. They are created by association between a cation and an anion in stoichiometric proportions thus ensuring the electrical neutrality of the salt. The cations most widely used have a structure of the type of ammonium, imidazolium, pyridinium, pyrrolidinium, phosphonium, thiazolium, quinolinium and tetraminium.

The anions are preferably chosen from among the halides (F, Cl, Br, I); tetrafluoroborate (BF₄), hexafluorophosphate (PF₆), sulfate (SO₄), and hydrogen sulfate (HSO₄), anions with a carboxylate function: formates (HCOO), acetate (CH₃COO), trifluoroacetate (CF₃COO), propanoate (CH₃—CH₂—COO); sulfonylimide anions; bis((trifluoromethyl)sulfonyl)imide ((CF₃—SO₂)₂N) anions, bis(methylsulfonyl)imide ((CH₃—SO₂)₂N) anions, the dicyanamide anion (N(CN)₂); sulfonate anions: methylsulfonate (CH₃SO₃), trifluoromethylsulfonate (CF₃SO₃), benzenesulfonate (C₆H₅SO₃), p-toluenesulfonate (CH₃—C₆H₄—SO₃), perfluorobutylsulfonate (C₄F₉SO₃); sulfinate anions: (trifluoromethanesulfinate (CF₃SO₂), perfluorobutylsulfinate (C₄F₉SO₂), phosphate anions: dimethyl phosphate C₂H₇O₄P, diethyl phosphate, C₄H₁₁O₄P, dihydrogen phosphate (H₂PO₄), hydrogen phosphate (HPO₄) and phosphate (PO₄); phosphonate anions such as, for example, methylphosphonate (CH₃PO₃H), ethylphosphonate (C₂H₅PO₃H); and other anions such as, for example, hexafluoroarsenate (AsF₆), hexafluoroniobiate (NbF₆) and hexafluoroantimonate (SbF₆).

The electrolyte salts that can be used according to the invention can for example be chosen from among lithium salts such as, for example, lithium bis(trifluoromethanesulfonyl)imide (LiTFSI), lithium perchlorate (LiClO₄), lithium hexafluorophosphate (LiPF₆), sodium salts such as, for example sodium bis(trifluoromethanesulfonyl)imide (NaTFSI), and certain acids such as bis(trifluoromethanesulfonyl)imide acid (HTFSI), phosphoric acid and sulfuric acid.

The solvent of the electrolytic solutions defined in the point iii) above can be chosen from among polar aprotic solvents such as, for example, cyclic and linear carbonates (for example ethylene carbonate, propylene carbonate, butylene carbonate, dimethyl carbonate, diethyl carbonate, dipropyl carbonate, ethylmethyl carbonate, vinylene carbonate), cyclic ethers (for example tetrahydrofuran), ethers of polyethylene glycols of formula RO(CH₂CH₂O)ₙR′ in which R and R′ are CH₃ or C₂H₅, and 1≤n≤12, tetraalkyl sulfamides of formula RR′NSO₂NR″R′″ in which R, R′, R″ and R′″ are CH₃ or C₂H₅, 3-methyl-1,3-oxazolidine-2-one, and cyclic esters (for example γ-butyrolactone).

The solvent of the electrolytic solutions defined in the point iii) can also be an aqueous solvent such as water.

The gelling agents that can be used to solidify the ionic liquids or the solutions of at least one electrolyte salt and/or of at least one acid can for example be chosen from among cellulose, nitrocellulose, the carboxymethylcelluloses (CMC), etc.

The plasticizing agents that can be used to solidify the ionic liquids or the solutions of at least one electrolyte salt and/or of at least one acid can for example be chosen from among compounds pre-polymerized or polymerizing during the assembly of the electrochromic device and resulting from the polymerization of one or more monomers chosen from among ethylene oxide, propylene oxide, methyl methacrylate, methyl acrylate, acrylonitrile, methacrylonitrile, and vinylidene fluoride, said polymer having a structure of linear type, of comb, random, alternating or block type, which may be crosslinked or non-crosslinked. Polymers that can notably be cited include poly(methyl methacrylate) (PMMA), polyethylene oxide (PEO), polyacrylonitrile (PAN), and mixtures thereof.

The quantity of plasticizing and/or gelling agent present in the ionic liquid or in the electrolytic solution depends on the initial viscosity of the ionic liquid or of the electrolytic solution, on its nature, etc.

When the solid electrolyte is a plasticized or gelled ionic liquid, the quantity of plasticizing or gelling agent can vary from 20 to 70% approximately by weight with respect to the weight of the ionic liquid, and even more preferentially, from approximately 40 to 50%.

When the solid electrolyte is a plasticized or gelled electrolytic solution as defined above in the point iii), the quantity of plasticizing or gelling agent can vary from 20 to 80% by weight with respect to the total weight of the initial electrolytic solution, and even more preferentially, from 30 to 60%.

According to one embodiment, the electrolyte can be an opaque material or a transparent material.

According to one embodiment, the electrolyte preferably has a thickness varying from a few nanometers to a few hundreds of micrometers, preferably from 100 nm to 100 μm.

According to one embodiment of the invention, the first electrode and the second electrode are made of electrically conductive materials. Materials that can notably be cited include copper, iron, silver, platinum, gold, carbon and conductive polymers. The carbon can be of different types, carbon nanotubes, graphite or carbon black.

The two electrodes can take the form of a thin layer, having a thickness varying from 100 nm to 100 μm.

According to one embodiment of the invention, the electrochromic material comprises at least one conductive polymer chosen from among poly(3,4-ethylenedioxythiophene) (PEDOT), poly(3,4-ethylenedioxyselenophene) (PEDOS), poly(3,4-propylenedioxythiophene) (or PProDOT), 4,7-bis(2,3-dihydrothieno[3,4-b][1,4]dioxin-5-yl)-2-phenyl-1H-benzo[d]imidazole, 1,4-bis(2-(3,4-ethylenedioxy)thienyl)benzene (or BEDOT-B), copolymers based on pyrrole and on 3,4-ethylenedioxythiophene (or EDOT), copolymers of 4-aminodiphenylamine and of 4,4′-diaminodiphenylsulfone, poly[2,5-di(2-thienyl)-1H-pyrrole-1-(p-benzoic) acid], poly(9H—N-alkylcarbazoles), poly(3,6-dinitro-9H—N-alkylcarbazoles) and poly(3,6-diamino-9H—N-alkylcarbazoles); copolymers of tris-[4-(2-thienyl)phenyl]amine and of 2,2′-bithiophene, poly(tris(4-selen-2-yl)phenylamine, poly(2,3,5,6-tetrafluoroaniline), poly(3,4-ethylenedioxypyrrole), poly(aniline-co-ethyl-4-aminobenzoate), poly(1-(3-pyridinyl)-2,5-di(2-thienyl)-1H-pyrrole) and poly(1-(1,10-phenanthrolinyl)-2,5-di(2-thienyl)-1H-pyrrole);
an electrochromic oxide chosen from among: WO₃, NiO, IrOx, V₂O₅, Nb₂O₅, CoOx, CeO₂, TiO₂,
a polymer-oxide hybrid compound;
viologens;
a hexacyanometallate compound from the family of Prussian colors such as Prussian blue Fe₄[Fe(CN)₆]₃.

The thickness of the electrochromic materials varies according to the nature of the materials used. It is generally between 100 nm and 100 μm.

According to one embodiment of the invention in which the electrochromic device comprises a single substrate, the latter can be an opaque, translucent or transparent material that can for example be chosen from among papers, plastics, textile materials, glasses, metals, ceramics, wood, etc.

According to another embodiment of the invention in which the electrochromic device comprises a first substrate and a second substrate, the electrochromic cell composed of the counter-electrode, the layer of electrolyte and the working electrode being positioned between the two substrates, one of the two substrates is a translucent or transparent material and the other substrate can be an opaque, translucent or transparent material that can for example be chosen from among papers, plastics, textile materials, glasses, metals, ceramics, wood, etc.

Finally, also a subject of the invention are the various applications and uses of the electrochromic device for the display of data, the manufacturing of motor vehicle rear-view mirrors and of visors, the manufacturing of building glazing units or of optical camouflage in the infrared.

### BRIEF DESCRIPTION OF THE DRAWINGS

Other features, details and advantages of the invention will become apparent on reading the following detailed description, and of analyzing the attached drawings, in which

FIG. 1A shows an electrochromic device having a vertical architecture of the state of the art with five layers;

FIG. 1B shows an electrochromic device having a vertical architecture of the state of the art with four layers;

FIG. 1C shows an electrochromic device having a vertical architecture of the state of the art with three layers;

FIG. 2A shows an electrochromic device with three layers of the state of the art in a coplanar architecture by a section view;

FIG. 2B shows an electrochromic device with three layers of the state of the art in a coplanar architecture by a top view;

FIG. 2C shows an electrochromic device with three layers of the state of the art in a coplanar architecture by a perspective view;

FIG. 3 shows an electrochromic device according to a first embodiment of the invention;

FIG. 4 schematically shows the different steps in the manufacturing of the electrochromic device of FIG. 3;

FIG. 5 shows a chronoamperometry curve obtained from the electrochromic device of FIG. 3 with the current density (in mA/cm²) on the y axis and time on the x axis (in seconds);

FIG. 6 shows an electrochromic device according to a second embodiment of the invention;

FIG. 7 schematically shows the various steps in the manufacturing of the electrochromic device of FIG. 6;

FIG. 8 shows a chronoamperometry curve obtained from the electrochromic device of FIG. 6 with the current density (in mA/cm²) on the y axis and time on the x axis (in seconds).

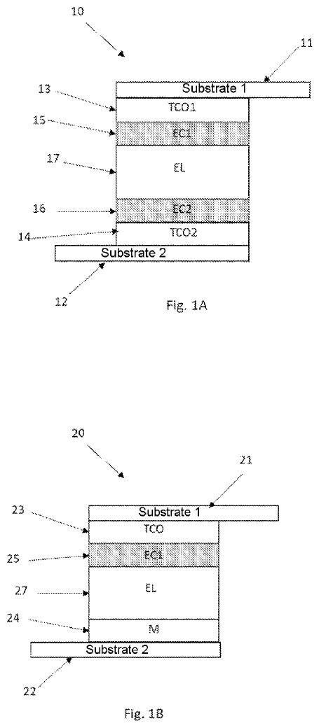

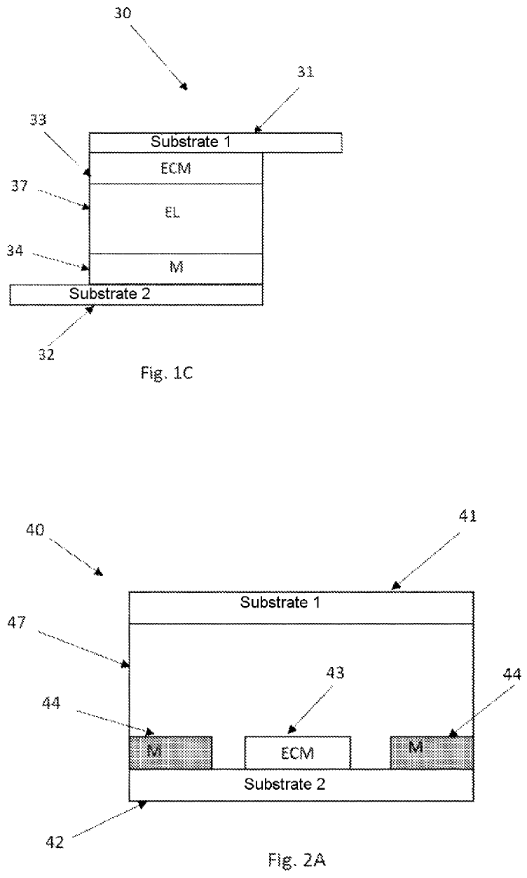

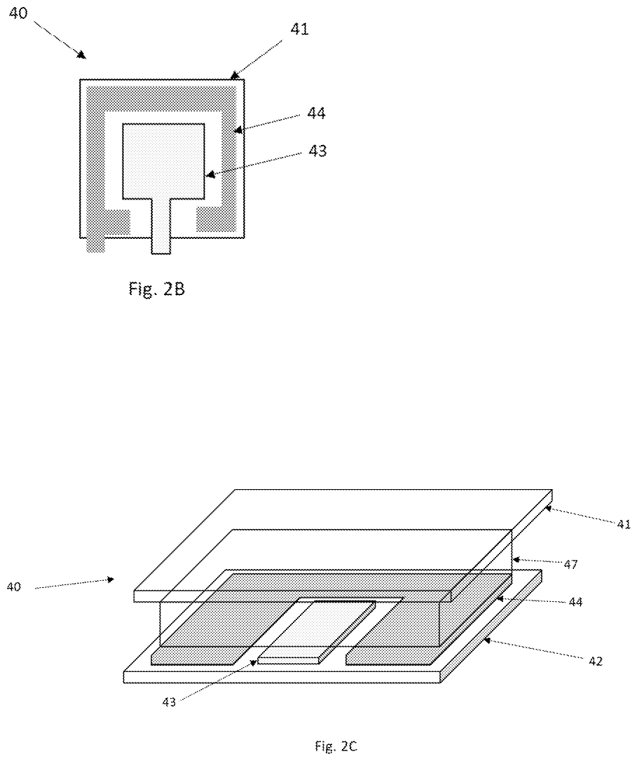

### DESCRIPTION OF THE EMBODIMENTS

The drawings and the description hereinbelow contain, for the most part, elements of a certain nature. They will therefore be able not only to serve to give a better understanding of the present invention, but will also contribute to the definition thereof, as appropriate.

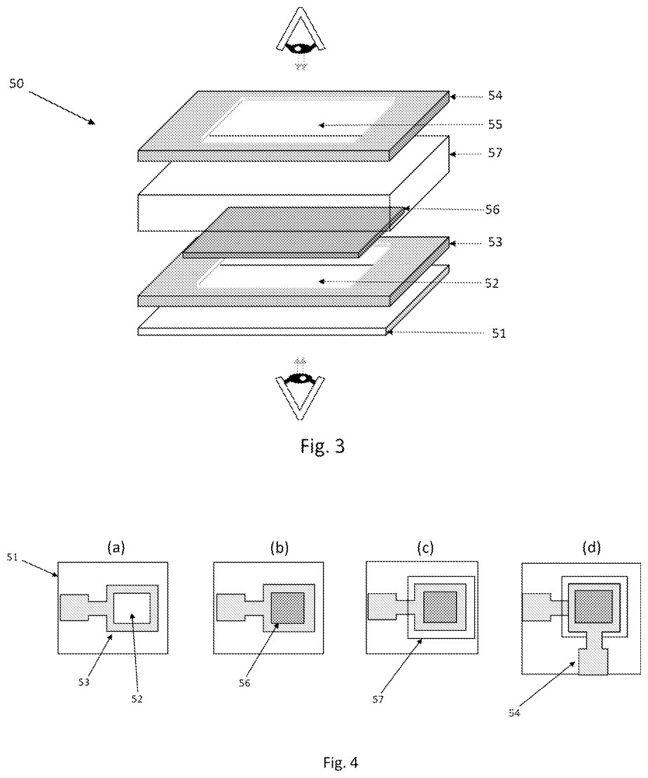

According to a first embodiment of the invention and with reference to FIG. 3, the electrochromic device 50 comprises a single substrate 51, a first electrode 53 and a layer of electrochromic material 56 placed in a first aperture 52 formed in the first electrode to form a working electrode, a layer of electrolyte 57, a second electrode 54 forming the counter-electrode in which a second aperture 55 is formed.

The layer of electrochromic material is adapted to be placed in the first aperture forming an electrical contact zone between the layer of electrochromic material 56 and the first electrode 53. The layer of electrochromic material is arranged in the first aperture so as to form the electrical contact zone. This electrical contact zone results for example by a lateral contact between a zone of the inner edge of the first aperture and a zone of the perimeter of the layer of electrochromic material.

According to one embodiment and as can be seen in FIG. 3, the layer of electrochromic material 56 can be of substantially the same size and the same form as the first aperture 52.

As a variant, the layer of electrochromic material 56 is slightly larger than the first aperture 52. Thus, the perimeter of the layer of electrochromic material 56 overflows slightly from the first aperture 52.

According to one embodiment, the layer of electrochromic material 56 is placed in the first aperture 52 such that the surface of the layer of electrochromic material and the surface of the first electrode 53 which are in contact with the layer of electrolyte are aligned and in continuity with one another. That is understood to mean that the two surfaces do not form a step. According to another embodiment, the layer of electrochromic material 56 is placed in the first aperture 52 such that a peripheral zone of the surface of the layer of electrochromic material 52 covers the perimeter of the first aperture.

According to the invention, the electrochromic device further comprises an electrical power supply means connected to the electrodes to apply an electrical voltage to the two electrodes in order to command the reversible change of color between an oxidated state and a reduced state of the layer of electrochromic material.

The counter-electrode 54 therefore comprises a surface in contact with the layer of electrolyte 57 and a surface forming a free surface. In the case where the surface of the single substrate 51 opposite that which is in contact with the working electrode forms a display surface through which a user represented by an eye in FIG. 3 observes the change of color of the layer of electrochromic material 56, the substrate must be made of a transparent material. In the case where the free surface of the counter-electrode 54 forms a display surface and the user observes the change of color of the layer of electrochromic material through the second aperture 55, the layer of electrolyte 57 must be a transparent material. In this case, the substrate 51 which is placed under the layer of electrochromic material can advantageously be used as contrast background.

According to a second embodiment of the invention and with reference to FIG. 6, the electrochromic device 60 comprises a single substrate 61, a second electrode forming the counter-electrode 64 in which a second aperture 65 is formed, a layer of electrolyte 67, a first electrode 63 and a layer of electrochromic material 66 placed in a first aperture 62 formed in the first electrode 63 to form together a working electrode. In this second embodiment, the counter-electrode 64 comprises a surface in contact with the substrate 61 and a surface in contact with the layer of electrolyte 67. The working electrode comprises a surface in contact with the layer of electrolyte and a free surface.

In the case where the surface of the single substrate opposite that which is in contact with the counter-electrode forms a display surface through which a user observes the change of color of the layer of electrochromic material, the substrate and the layer of electrolyte must be made of a transparent material. In the case where the free surface of the working electrode forms a display surface oriented toward the user, there is no constraint on the choice of materials in terms of transparency since the user can view the change of color directly via the first aperture 62 formed in the first electrode 63.

By virtue of this novel architecture, it is possible to deposit the materials of the device layer by layer, so it is no longer necessary to use a second substrate which is used generally as electrode support in the lamination process in the architectures of the state of the art.

It is also possible to add a second substrate. In this case, one of the two substrates must be a transparent material to be able to view the change of color taking place in the electrochromic layer.

In the two embodiments illustrated in FIGS. 3 and 6, it is possible to deposit a protection layer via various techniques in order to protect the electrochromic device with respect to the environment: oxygen, light, humidity.

The two embodiments of the electrochromic device are illustrated below using two examples.

### EXAMPLES

### Example 1

In this example 1, the electrochromic device of FIG. 3 was prepared, with the order of deposition to form the stack as follows:
a substrate 51: paper in which the surface which receives the electrode layer can be treated;
a first electrode 53: a layer of silver metallic ink and a second, conductive carbon layer;
a layer of electrochromic material 56: ink comprising an electrochromic polymer poly(3,4-ethylenedioxy)thiophene (PEDOT) and a conductive polymer poly(styrene sulfonate) (PSS);
a layer of electrolyte 57: the electrolyte was prepared by using LiTFSI:EmimTFSI (1:9% mol) and a UV photopolymer;
a second electrode 54: a layer of carbon ink and a second layer of metallic ink.

FIG. 4 illustrates the various deposition steps to produce the electrochromic device of FIG. 3. The layers of silver metallic ink and of carbon were deposited by screen-printing on the paper substrate 51 to form the first electrode 53. The first electrode 53 is connected to an electrical power supply via a conductive track. A first aperture 52 is produced in the first electrode using the specific pattern of the screen-printing mask. A layer of electrochromic material 56 of PEDOT:PSS was deposited industrially by screen-printing on the first electrode in the first aperture. The first electrode and the layer of electrochromic material deposited in the first aperture together form a working electrode. The layer of electrolyte 57 was obtained by mixing LiTFSI:EmimTFSI (1:9% mol) and UV photopolymer. The layer of electrolyte 57 is then deposited on the working electrode by screen-printing and “hardened” by UV exposure. In a final step, a second electrode 54 which has substantially the same form and the same size as the first electrode is deposited on the electrolyte by screen-printing. This second electrode forms the counter-electrode which is connected to an electrical power supply via a conductive track and by using the same materials as those employed for the counter-electrode. This electrical power supply makes it possible to apply an electrical potential difference between the two electrodes.

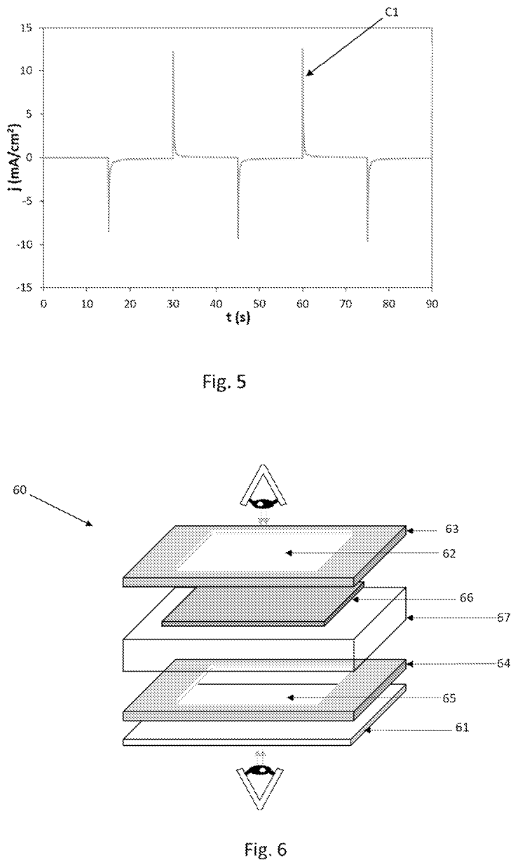

The electrochromic device of FIG. 3 was then tested, in the 0 to −1.5 V potential range. FIG. 5 shows an extract C1 of the chronoamperometry curves of the electrochromic device thus obtained, the current density (in mA/cm²) being a function of time (in seconds). This extract demonstrates the high switching speed of the system. The switching of the electrochromic device takes place in less than 3 seconds in coloring and in 2 seconds in decoloring for a 2 cm² surface area, which is as fast as the electrochromic devices of the state of the art.

### Example 2

In this example 2, the electrochromic device of FIG. 6 was prepared, with the order of deposition to form the stack as follows:
a substrate 61: paper;
an electrode 64: a layer of silver metallic ink;
a layer of electrolyte 67: the electrolyte was prepared by using LiTFSI:EmimTFSI (1:9% mol) and a UV photopolymer;
a layer of electrochromic material 66: ink comprising an electrochromic polymer poly(3,4-ethylenedioxy)thiophene (PEDOT) and a conductive polymer poly(styrene sulfonate) (PSS);
an electrode 63: a layer of silver metallic ink.

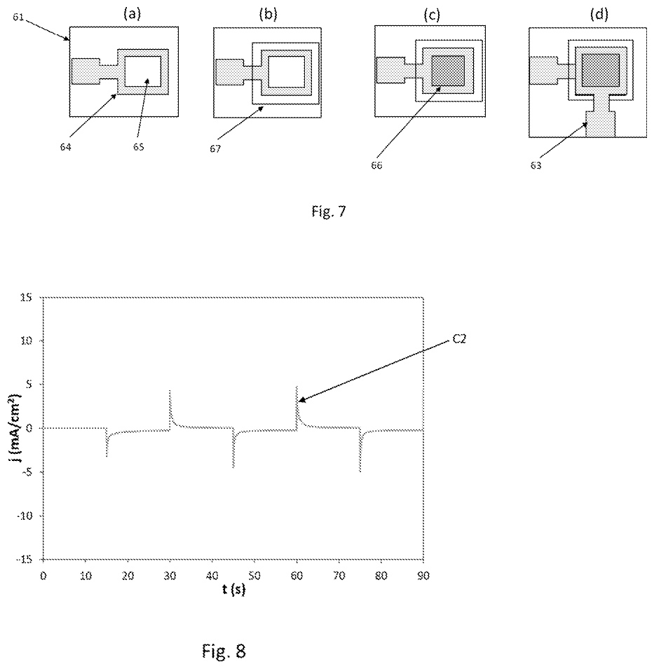

FIG. 7 shows the various deposition steps to produce the electrochromic device of FIG. 6. The silver metallic ink was deposited by screen-printing on a paper substrate 61 to form a second electrode 64 with an aperture 65. This second electrode forms the counter-electrode which is connected to an electrical power supply via a conductive track and by using the same materials as those employed for the counter-electrode. A layer of electrolyte 67 comprising LiTFSI:EmimTFSI (1:9% mol) and UV photopolymer is deposited on the counter-electrode 64 by screen-printing then “hardened” by UV exposure. A layer of electrochromic material 66 of PEDOT:PSS was deposited industrially by screen-printing on the layer of electrolyte 67. In a final step, a first electrode 63 which has substantially the same form and the same size as the counter-electrode is deposited by screen-printing and comprising an aperture 62. The layer of electrochromic material and the first electrode thus form the working electrode which is linked to an electrical power supply via a conductive track using the same material as the first electrode. This electrical power supply allows the application of a potential difference between the two electrodes.

The electrochemical stability of the electrochromic device of FIG. 6 was then tested, in the 0 to −1.5 V potential range. FIG. 8 shows an extract C2 of the chronoamperometry curves of the electrochromic device thus obtained, the current density (in mA/cm²) being a function of time (in seconds). This extract demonstrates the high switching speed of the system. The switching of the electrochromic device takes place in less than 3 seconds in coloring and in 2 seconds in decoloring for a 2 cm² surface area, which is as fast as the electrochromic devices of the state of the art.

The chronoamperometry curves obtained for the two examples show that the presence of the apertures in the electrodes does not affect the electrochemical stability of the electrochromic device in the conditions used for coloring and decoloring respectively. That makes it possible, in the case of industrialization of the electrochromic device in accordance with the present invention, to greatly reduce the production cost because the use of a layer of conductive transparent oxide produced by physical deposition (PVD) or chemical vapor phase deposition (CVD) is no longer required.

### INDUSTRIAL APPLICATION

The invention can be applied notably in various forms. The electrochromic device of the present invention can advantageously be used for:
the display of data (text and/or image screen, pixelation system, signaling panels, authentication of counterfeit products, etc.);
the manufacturing of motor vehicle rear-view mirrors and of visors, in particular visors of motorcycle helmets. The use of the electrochromic device makes it possible to avoid glare from the headlights of other vehicles and from the sun;
the manufacturing of building glazing units, in order to limit sunlight during summer or the loss of heat from rooms during winter;
the manufacturing of thermal control and thermal camouflage by modulating the absorption in the infrared.

1. An electrochromic device, comprising:
at least one substrate;
a first electrode comprising a first aperture;
a second electrode (54, 64) comprising a second aperture, wherein the first electrode and the second electrode are positioned such that the first aperture and the second aperture are opposite;
a layer of electrochromic material placed in the first aperture of the first electrode so as to form at least one electrical contact zone between the layer of electrochromic material and the first electrode, said layer of electrochromic material and said first electrode thus together forming a working electrode and the second electrode forming a counter-electrode;
a layer of electrolyte sandwiched between the working electrode and the counter-electrode; and
an electrical power supply means configured to apply an electrical voltage to the first electrode and the second electrode.

2. The electrochromic device as claimed in claim 1, wherein the first electrode and the second electrode are made of electrically conductive materials.

3. The electrochromic device as claimed in claim 2, wherein each of the first electrode and the second electrode are selected from the group consisting of copper, iron, silver, platinum, gold, carbon and conductive polymers.

4. The electrochromic device as claimed in claim 1 wherein the layer of electrolyte is a transparent material.

5. The electrochromic device as claimed in claim 1 wherein the layer of electrolyte is an opaque material.

6. The electrochromic device as claimed in claim 1 wherein the layer of electrolyte is selected from the group consisting of:
i) ionic liquids gelled or plasticized by at least one gelling or plasticizing agent;
ii) ionic liquids mixed with a thermo- or UV photo-polymerizable monomer/oligomer,
iii) electrolyte solutions of at least one electrolyte salt and/or of at least one acid in solution in a solvent, said solutions being gelled or plasticized by at least one gelling or plasticizing agent,
iv) electrolytic solutions comprising at least one oxide, and
v) thin layers of a material comprising at least one hydrated oxide selected from the group consisting of hydrated Ta₂O₅ and hydrated ZrO₂.

7. The electrochromic device as claimed in claim 1 wherein the electrochromic material comprises
at least one conductive polymer selected from the group consisting of poly(3,4-ethylenedioxythiophene), poly(3,4-ethylenedioxyselenophene), poly(3,4-propylenedioxythiophene), 4,7-bis(2,3-dihydrothieno[3,4-b][1,4]dioxin-5-yl)-2-phenyl-1H-benzo[d]imidazole, 1,4-bis(2-(3,4-ethylenedioxy)thienyl)benzene, copolymers based on pyrrole and on 3,4-ethylenedioxythiophene, copolymers of 4-aminodiphenylamine and of 4,4′-diaminodiphenylsulfone, poly[2,5-di(2-thienyl)-1H-pyrrole-1-(p-benzoic) acid], poly(9H—N-alkylcarbazoles), poly(3,6-dinitro-9H—N-alkylcarbazoles) and poly(3,6-diamino-9H—N-alkylcarbazoles); copolymers of tris-[4-(2-thienyl)phenyl]amine and of 2,2′-bithiophene, poly(tris(4-selen-2-yl)phenylamine, poly(2,3,5,6-tetrafluoroaniline), poly(3,4-ethylenedioxypyrrole), poly(aniline-co-ethyl-4-aminobenzoate), poly(1-(3-pyridinyl)-2,5-di(2-thienyl)-1H-pyrrole) and poly(1-(1,10-phenanthrolinyl)-2,5-di(2-thienyl)-1H-pyrrole),
an electrochromic oxide chosen from among: WO₃, NiO, IrOx, V₂O₅, Nb₂O₅, CoOx, CeO₂, TiO₂,
a polymer-oxide hybrid compound,
viologens, and
a hexacyanometallate compound from the family of Prussian colors.

8. The electrochomic device of claim 1 wherein the at least one substrate is a single substrate, and wherein said single substrate is an opaque, translucent or transparent material selected from the group consisting of papers, plastics, textile materials, glasses, metals, ceramics and wood.

9. The electrochromic device as claimed in claim 1, comprising:
a first substrate;
the working electrode and the counter-electrode;
the layer of electrolyte sandwiched between the working electrode and the counter-electrode;
a second substrate, and wherein one of the first substrate and the second substrate is a translucent or transparent material and one of the first substrate and the second substrate is an opaque, translucent or transparent material selected from the group consisting of papers, plastics, textile materials, glasses, metals, ceramics and wood.

10. A method of using the electrochromic device as defined in claim 1, selected from the group consisting of display of data, production of motor vehicle rear-view mirrors or of visors, and production of building glazing units or optical camouflage in infrared.
